(19) United States
(12) Patent Application Publication
(10) Pub. No.: US 2025/0362274 A1
(43) Pub. Date: Nov. 27, 2025

(54) SYSTEMS AND METHODS TO DETERMINE PARTITION COEFFICIENTS BETWEEN CRUDE OIL AND AN AQUEOUS PHASE

(71) Applicant: Saudi Arabian Oil Company, Dhahran (SA)

(72) Inventors: Sehoon Chang, Boston, MA (US); Wei Wang, Quincy, MA (US); Gawain Thomas, Shirley, MA (US)

(21) Appl. No.: 18/670,097

(22) Filed: May 21, 2024

(51) Int. Cl. G01N 30/06; B01L 3/00; G01N 30/74

(52) U.S. Cl. CPC G01N 30/06; B01L 3/502715; G01N 30/74; B01L 2200/027; B01L 2300/0867

(57) ABSTRACT

The disclosure relates to systems and methods to determine partition coefficients between crude oil and an aqueous phase for oil and gas tracers. The systems and methods include a microfluidic mixing chip to mix the crude oil and aqueous phase, an oil/water separation tube capable of separating the oil and aqueous phases, and a high-performance liquid chromatography (HPLC) system with optical detection to collect tracer concentration data to determine the partition coefficients.

### FIELD

The disclosure relates to systems and methods to determine partition coefficients between crude oil and an aqueous phase for oil and gas tracers. The systems and methods include a microfluidic mixing chip to mix the crude oil and aqueous phase, an oil/water separation tube capable of separating the oil and aqueous phases, and a high-performance liquid chromatography (HPLC) system with optical detection to collect tracer concentration data to determine the partition coefficients.

### BACKGROUND

Oil and gas tracers can be used to evaluate and understand production data and well connectivity, and to perform pressure test analysis.

The partition coefficient of a compound is defined as the ratio of the concentration of the compound in two immiscible solvents, such as oil and water, at equilibrium.

### SUMMARY

The disclosure relates to systems and methods to determine partition coefficients between crude oil and an aqueous phase for oil and gas tracers. The systems and methods include a microfluidic mixing chip to mix the crude oil and aqueous phase, an oil/water separation tube capable of separating the oil and aqueous phases, and an HPLC system with optical detection to collect tracer concentration data to determine the partition coefficients.

The systems and methods can provide partition coefficients more accurately, more rapidly, more inexpensively, more sustainably, with less solvent, and/or with less analyte relative to certain other systems and methods for determining partition coefficients, such as the shake-flask method. The systems and methods can reduce safety and health risks by reducing the amounts of hazardous solvents used relative to certain other systems and methods for determining partition coefficients, such as the shake-flask method.

The systems and methods can allow for the determination of the partition coefficients of multiple tracers in a mixture simultaneously. The systems and methods can allow for the detection of both fluorescent and non-fluorescent tracers. The systems and methods can be used with crude oil which has a relatively high fluorescence background signal and may not be compatible with certain other systems and methods. The systems and methods can provide partition coefficients for mixtures containing crude oil without signal interference from fluorescence and/or UV-Vis absorbance of the crude oil.

In a first aspect, the disclosure provides a method, including: injecting an aqueous solution including a first tracer into a first inlet of a microfluidic mixing device and injecting crude oil into a second inlet of the microfluidic mixing device; mixing the aqueous solution and the crude oil in the microfluidic mixing device to form a mixture including the aqueous solution and the crude oil; disposing the mixture in a separation tube including functionalized fibers; using the separation tube to separate an aqueous phase of the mixture from a crude oil phase of the mixture; using a high-performance liquid chromatography (HPLC) system capable of detecting an optical parameter to measure the first tracer in the aqueous phase; and using the measurement of the first tracer in the aqueous phase to determine a partition coefficient between the crude oil and the aqueous solution of the first tracer.

In some embodiments, the method further includes constructing a calibration curve for the first tracer based on the optical parameter and using the calibration curve with the measurement of the first tracer in the aqueous phase to determine the partition coefficient between the crude oil and the aqueous solution of the first tracer.

In some embodiments, the aqueous phase flows through the separation tube and the crude oil phase is retained in the separation tube due to the functionalized fibers.

In some embodiments, the functionalized fibers include —CₙH₂ₙ₊₁ groups, where n=8-20.

In some embodiments, the functionalized fibers include octadecyl groups.

In some embodiments, the functionalized fibers include glass wool fibers functionalized with the —CₙH₂ₙ₊₁ groups.

In some embodiments, the method further includes, prior to injecting the aqueous solution and the crude oil into the microfluidic mixing device, injecting the aqueous solution including the first tracer into the first inlet of the microfluidic mixing device.

In some embodiments, the optical parameter includes a member selected from the group consisting of UV-Vis absorption, fluorescence, time-resolved fluorescence, a Raman signal, and an IR signal.

In some embodiments, the aqueous solution further includes a second tracer, and the method further includes determining a partition coefficient between the crude oil and the aqueous solution of the second tracer.

In some embodiments, the method further includes constructing a calibration curve for the second tracer based on the optical parameter.

In some embodiments, the aqueous solution includes a member selected from the group consisting of fresh water, seawater, and brine.

In a second aspect, the disclosure provides a system including: a microfluidic mixing chip including: a first inlet, a second inlet, an outlet, and an internal channel that provides fluid communication between the first inlet, the second inlet, and the outlet; a separation tube including functionalized fibers; and a high-performance liquid chromatography (HPLC) system capable of detecting an optical parameter. The outlet of the microfluidic mixing chip is in fluid communication with an inlet of the separation tube. An outlet of the separation tube is in fluid communication with an inlet of the high-performance liquid chromatograph system.

In certain embodiments, the functionalized fiber includes —CₙH₂ₙ₊₁ groups, where n=8-20.

In certain embodiments, the functionalized fibers include octadecyl groups.

In certain embodiments, the functionalized fibers include glass wool functionalized with the —CₙH₂ₙ₊₁ groups.

In certain embodiments, the optical parameter includes a member selected from the group consisting of UV-Vis absorption, fluorescence, time-resolved fluorescence, a Raman signal, and an IR signal.

In certain embodiments, the system is configured so that, during use of the system, when an aqueous solution including a tracer is input into the first inlet and crude oil is input into the second inlet: the microfluidic mixing chip mixes the aqueous solution and the crude oil to form a mixture including the aqueous solution and the crude oil; the separation tube separates an aqueous phase of the mixture from a crude oil phase of the mixture; and the HPLC system measures the tracer in the aqueous phase.

In certain embodiments, the separation tube has a length of from 50 mm to 500 mm.

In certain embodiments, the separation tube has a diameter of from 1 mm to 5 mm.

In certain embodiments, the separation tube includes a tube including a member selected from the group consisting of borosilicate glass and polyether ether ketone.

### BRIEF DESCRIPTION OF THE FIGURES

FIG. 1 depicts a schematic of a system for determining the partition coefficient between crude oil and water of an oil and gas tracer.

FIG. 2 is a flowchart for a method of measuring partition coefficients for an oil and gas tracer.

FIG. 3A shows a graph of HPLC data of tracers.

FIG. 3B shows a graph of HPLC data of tracers after partitioning.

FIG. 4 shows a bar graph of partition coefficients.

### DETAILED DESCRIPTION

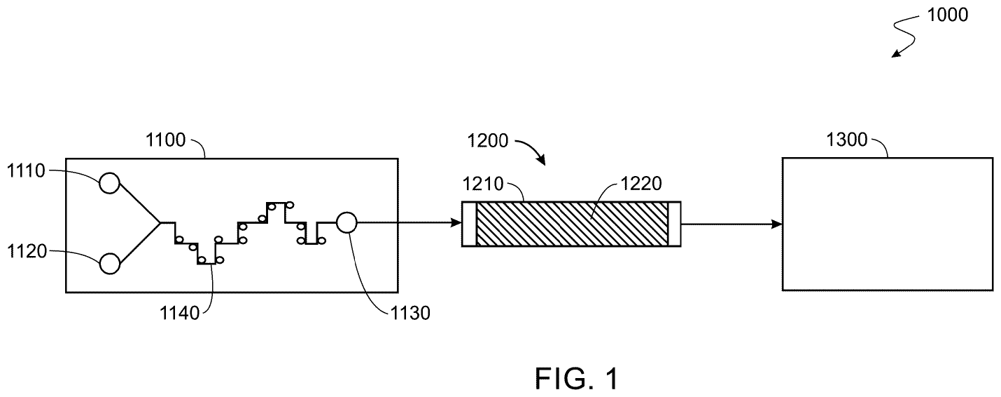

FIG. 1 depicts a schematic of a system 1000 for determining the partition coefficient between crude oil and water of an oil and gas tracer. Oil and gas tracers can be used to gauge how fluid flows in a reservoir. In general, oil and gas tracers are molecules that have absorbance in the UV-Vis spectrum and/or are fluorescent and are relatively stable in reservoir conditions. Examples of oil and gas tracers include fluorobenzoic acid-based molecules, dipicolinic acid-based molecules, and naphthalenesulfonate-based molecules.

The system 1000 includes a microfluidic mixing chip 1100 with a first inlet 1110, a second inlet 1120, an outlet 1130, and an internal channel 1140 that provides fluid communication between the first inlet 1110, the second inlet 1120, and the outlet 1130. In some embodiments, the microfluidic mixing chip includes a teardrop mixer (a microfluidic mixing device and specifically designed for oil). An aqueous solution including the tracer can be input into the first inlet 1110 and crude oil can be input into the second inlet 1120. The aqueous solution and the crude oil are combined within the internal channel 1140 so that they are mixed in the microfluidic mixing chip 1100. The mixture exits the microfluidic mixing chip 1100 via the outlet 1130. In general, the microfluidic mixing chip 1100 is designed to provide maximum contact between the two phases as they pass along the internal channel 1140. In general, the volume and path length of the internal channel 1140 are selected such that further increasing the volume or path length will not lead to significant changes in the mixing but are not excessively large to avoid wasting time and/or solvents. The mixed phases are then passed through an oil/water separation tube 1200.

Downstream of the outlet 1130 of the microfluidic mixing chip 1100, the system 1000 includes an oil/water separation tube 1200 that receives the mixture. The oil/water separation tube 1200 separates the aqueous and crude oil phases present in the mixture. In general, the oil/water separation tube 1200 includes a capillary tube 1210 packed with functionalized fiber 1220. The functionalized fiber 1220 is functionalized with a hydrophobic group giving the functionalized fiber 1220 a relatively strong affinity to hydrophobic components (see discussion below). Thus, the aqueous phase can pass through the oil/water separation tube 1200 while the crude oil phase is retained or separated. Without wishing to be bound by theory, it is believed that the oil/water separation tube 1200 can separate the crude oil and aqueous phases faster, with reduced sample volume, with reduced fouling, and/or with reduced degradation relative to certain other systems and methods for separating crude oil and aqueous phases, such as gravity separation and membrane separation. After leaving the separation tube 1200, the aqueous phase is sent to a detection system 1300.

In some embodiments, the length of the capillary tube 1210 is at least 50 (e.g., at least 100, at least 150, at least 200, at least 250, at least 300, at least 350, at least 400, at least 450) mm and/or at most 500 (e.g., at most 450, at most 400, at most 350, at most 300, at most 250, at most 200, at most 150, at most 100) mm. In some embodiments, the diameter of the capillary tube 1210 is at least 1 (e.g., at least 2, at least 3, at least 4) mm and/or at most 5 (e.g., at most 4, at most 3, at most 2) mm.

Generally, the capillary tube 1210 can include borosilicate glass. In certain embodiments, a polyether ether ketone (PEEK) tube or polymer tube can be used as the capillary tube 1210. Without wishing to be bound by theory, it is believed that PEEK and polymer tubes are resistant to crude oil.

In general, the detection system 1300 can be any appropriate detection system. In some embodiments, the detection system 1300 includes an HPLC system with an appropriate optical detector such as a fluorescence detector, a UV-Vis diode array detector (DAD), a Raman spectrometer, and/or a thermographic camera. In some embodiments, the detection system 1300 includes a 2D HPLC system. Without wishing to be bound by theory, it is believed that a 2D HPLC system can improve the sensitivity of measurements by separation of residual materials (e.g., polyaromatic hydrocarbons) from the crude oil. Without wishing to be bound by theory, it is believed that the oil/water separation tube 1200 can prevent contamination of the HPLC. The oil/water separation tube 1200 and detection system 13000 provide two types of separation sequentially (oil/water separation and HPLC tracer separation (separation of the tracers from the solution)).

In general, the functionalized fiber 1220 includes a substrate functionalized with the hydrophobic group. In some embodiments, the substrate is glass wool (glass fibers). In some embodiments, the functionalized fiber is functionalized with (CₘH₂ₘ₊₁O)₃—Si—CₙH₂ₙ₊₁, where m=1-4 and n=8-20. Accordingly, the functionalized fiber becomes functionalized with the CₙH₂ₙ₊₁ groups. Without wishing to be bound by theory, it is believed that the functional groups are covalently bonded to the substrate resulting in the functionalized fiber 1220 being very stable. It is also believed that the functionalized fibers 1220 are highly hydrophobic and exhibit strong affinity to hydrophobic components from the crude oil.

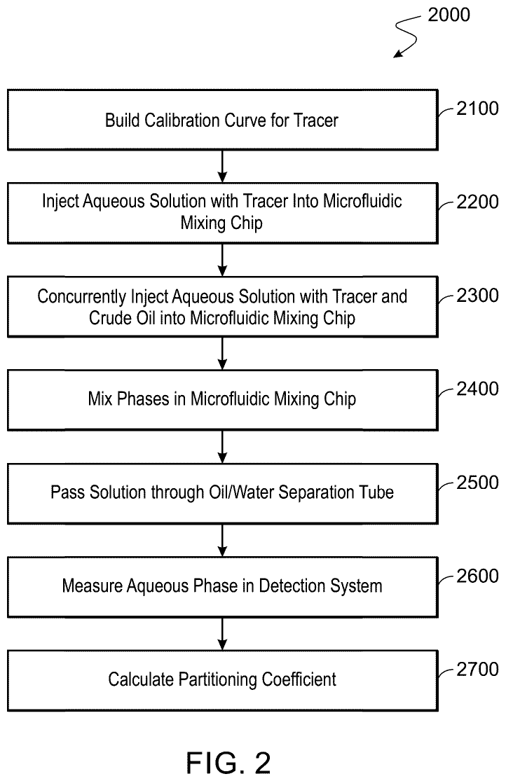

FIG. 2 is a flowchart for a method 2000 of measuring partition coefficients for an oil and gas tracer using the system 1000.

In step 2100 an optical property of the tracer in water at different concentrations is measured using the detection system 1300 to determine reference points and build a calibration curve. The optical property can include UV-Vis absorbance, fluorescence, time-resolved fluorescence, Raman signal, and/or IR signal. In some embodiments, the step 2100 can be performed using the system 1000 without injecting crude oil into the second inlet 1120 of the microfluidic mixing chip 1100.

In step 2200, a tracer solution including the tracer dissolved in an aqueous solution (e.g., fresh water, seawater, brine) is injected into the first inlet 1110 of the microfluidic mixing chip 1100, for example using a first syringe pump.

In step 2300 the tracer solution is injected into the first inlet 1110 of the microfluidic mixing chip 1100, for example using a first syringe pump and concurrently, crude oil is injected into the second inlet 1120 of the microfluidic mixing chip 1100, for example using a second syringe pump different from the first syringe pump. The volumes injected are such that when mixed, the crude oil and tracer solution should be in a 1:1 ratio. Injecting the tracer solution without and with crude oil in the steps 2200 and 2300 respectively allow the observation of the concentrations of the tracer without and with exposure to crude oil at the same instrumental measurement conditions relatively efficiently.

In step 2400, the tracer solution and crude oil are thoroughly mixed in the microfluidic mixing chip 1100 to form a mixture including the crude oil and tracer solution. The output of the microfluidic mixing chip 1100 can be go directly into the oil/water separation tube 1200.

In step 2500, the mixture is passed through the oil/water separation tube 1200 to separate the crude oil and aqueous phases. Without wishing to be bound by theory, it is believed that the crude oil phase is retained in the hydrophobic fiber matrix while the aqueous phase passes through and exits the oil/water separation tube 1200. After the oil/water separation tube 1200, the aqueous phase is collected and sent to the detection system 1300.

In step 2600, the separated aqueous phase is sent to the detection system 1300 to measure the optical parameter of the tracer.

In step 2700, the partition coefficient is calculated using the measurement from step 2600 and the reference points and calibration curve from step 2100. The partition coefficient of a substance “A” is defined as

$$K = {[ A ]}_{org} / {[ A ]}_{aq} ,$$

where [A]_{org} is the concentration of substance A in the organic phase, and [A]_{aq} is the concentration of substance A in the water phase, with equal volumes of organic and aqueous phases at equilibrium. The detection system 1300 and the calibration curve from the step 2100 can provide [A]_{aq}. [A]ₜₒₜₐₗ can be obtained from the step 2200 and [A]_{org} can be calculated as [A]_{org}=[A]ₜₒₜₐₗ−[A]_{aq}.

In general, the concentration of the tracer in the steps 2100, 2200, and 2300 depends on the quantification limits of the detection system 1300. In some embodiments, the concentration of the tracer is at least 0.001 (e.g., at least 0.01, at least 0.1, at least 1, at least 10, at least 100, at least 1000) ppm and/or at most 10000 (e.g., at most 1000, at most 100, at most 10, at most 1, at most 0.1, at most 0.01) ppm.

Generally, the flow rate depends on the microfluidic mixing chip 1100 and oil/water separation tube 1200. In certain embodiments, the flow rate is at least 0.05 (e.g., at least 0.06, at least 0.07, at least 0.08, at least 0.09, at least 0.1, at least 0.2, at least 0.3, at least 0.4) ml/min and/or at most to 0.5 (e.g., at most 0.4, at most 0.3, at most 0.2, at most 0.1, at most 0.09, at most 0.08, at most 0.07, at most 0.06) ml/min. Without wishing to be bound by theory, it is believed that the flow rate determines the segment ratio after mixing, which is ideally close to a 1:1 ratio for efficient mixing.

In certain embodiments, the tracer solution in the steps 2100, 2200, and 2300 includes two or more (e.g., three or more, four or more, five or more, ten or more) tracers and the partition coefficient is determined for each tracer in the step 2700. Reference points are determined, and a calibration curve is constructed for each tracer.

In general, the system 1000 and the method 2000 can be used to measure partition coefficients for any oil field chemicals (including polymers) detectable by UV-Vis and/or a fluorescence detection method and/or are capable of being functionalized with a functional group detectable by UV-Vis and/or a fluorescence detection method. The measurements can also be performed at different temperatures, pH, and/or salinities by controlling the conditions of the aqueous solutions.

In addition to oil and gas tracers, the system 1000 and method 2000 can be used for compounds relevant in the food industry, toxicology, a biological compound, and/or environmental contaminant analysis.

### Example

A partition coefficient detection system was constructed using a teardrop microfluidic mixer (micronit), a functionalized glass fiber packed capillary tube oil/water phase separator, and a 1D HPLC UV-Vis detector (Agilent, 1290 Infinity HPLC system).

To prepare the functionalized glass fiber packed capillary tube oil/water phase separator, a hydrophobic fiber filtration material was prepared by chemically functionalizing surfaces of glass wool. 5 g of glass wool (Ohio Valley Specialty) was washed with DI water in an ultrasonic bath, separated from the water, then dried. The washed glass wool was immersed in 20 mL Piranha solution (3:1 mixture of concentrated sulfuric acid and 30% hydrogen peroxide) for 30 mins, then the treated glass wool was removed from the Piranha solution and rinsed with DI water until the pH value of the water used for rinsing was near neutral pH (pH=7±1), as monitored by a pH meter. The glass wool was placed into 100 mL of a water-ethanol mixture (20:80 in volume ratio). 1 mL silane coupling agent, octadecyltriethoxysilane (Gelest, Purity 92%) was added under magnetic stirring. 1 mL of 29.5 wt. % ammonium hydroxide solution was added under magnetic stirring. The reaction was allowed to continue for 12 hours under stirring and then heated to boiling for 15 mins. After cooling to room temperature, the treated glass wool was removed and rinsed by ethanol and DI water, then dried in air.

Without wishing to be bound by theory, it is believed that the piranha solution treatment generates hydroxyl groups (—OH) on the surface of silica glass, then the hydrophobic octadecyl groups (—(CH₂)₁₇—CH₃) were grafted onto the surface of glass through hydrolysis reaction of silane agent octadecyltrioxysilane with ammonia in solution. It is also believed that the chemical reaction is:

$$≡ Si - O H + {( {CH}_{3} C {H}_{2} O )}_{3} - S i - {( C {H}_{2} )}_{17} - C {H}_{3} + {H}_{2} O \to ≡ Si - O - Si - {( {OCH}_{2} C {H}_{3} )}_{2} - {( C {H}_{2} )}_{17} - C {H}_{3} + {CH}_{3} C {H}_{2} OH$$

Without wishing to be bound by theory, it is believed that basic pH conditions can accelerate the reaction. Thus, ammonia can be used to increase the pH to accelerate the reaction.

At least three samples of known concentrations were used to build calibration curves for each tracer. Using the partition coefficient detection system, partition coefficients of the tracers dipicolinic acid (DPA), chelidamic acid (CDA), 4-chloropyridine-2,6-dicarboxylic acid (Cl-DPA), 1,5-naphthalenedisulfonate (1,5-NDS), 2-fluorobenzoic acid (2-FBA), and 4-chlorobenzyl alcohol (4-CBA) were measured in at 100 ppm sea water multiple times, which resulted in very consistent data across replicates.

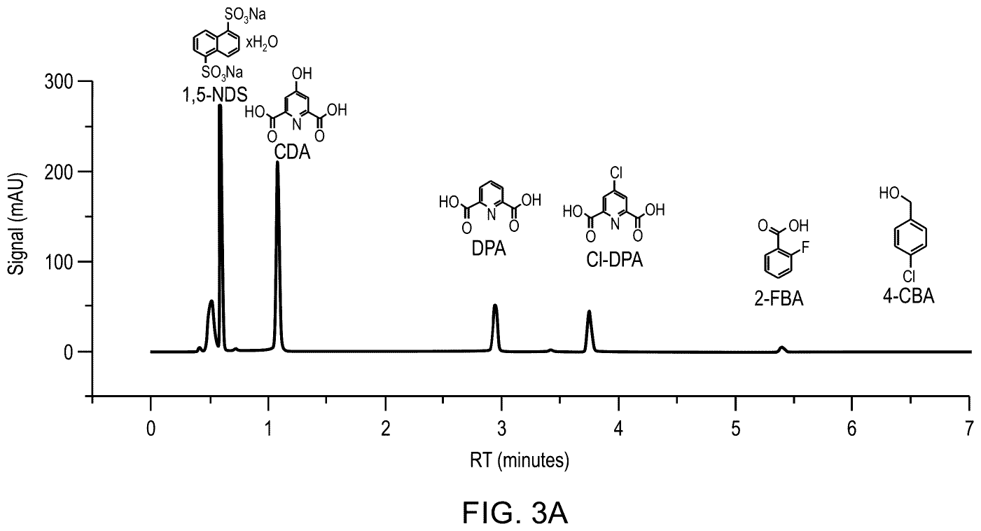

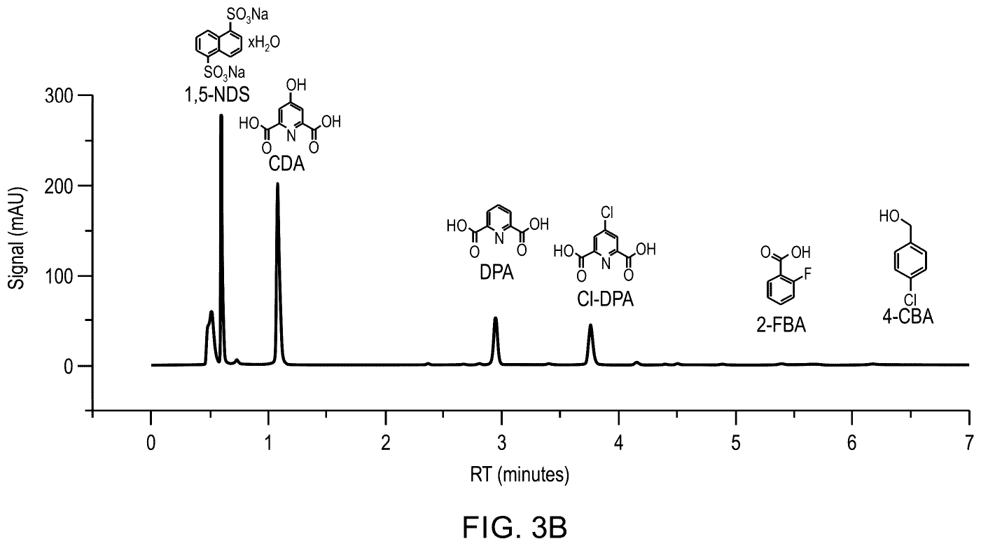

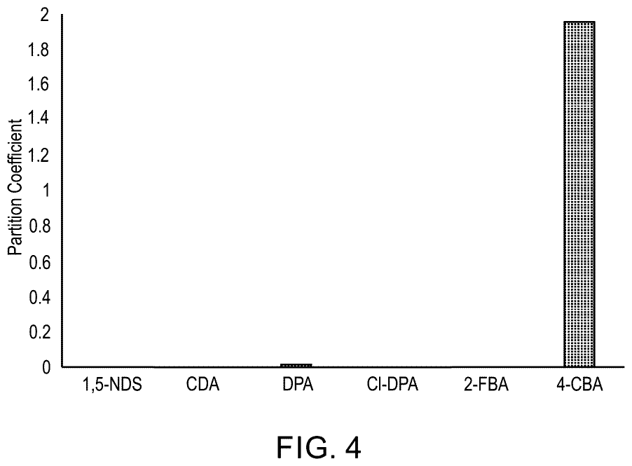

FIGS. 3A-3B show graphs of HPLC data and FIG. 4 shows a bar graph of partition coefficients. FIG. 3A corresponds to measurements of the tracer solution without crude oil injection and FIG. 3B corresponds to the tracer solution with crude oil injection, after partitioning. As shown in FIGS. 3A-3B, the HPLC UV-Vis chromatograms show all three 100 ppm concentrations of 4-CBA in DI water, after mixing with crude oil by microfluidic mixer and separation by the functionalized glass wool fiber system. The non-partitioning tracers, including 2-fluorobenzoic acid, did not show partitioning behavior whereas the partitioning tracer 4-CBA did show partitioning behavior, as shown in FIG. 4. The difference in signal of DPA relative to the other non-partitioning tracers may be due to the higher UV-Vis absorption of DPA relative to the other tracers at 100 ppm. The calculated value of partition coefficient (log P) of 4-CBA was 1.95, which was also similar to the value from the literature, 1.96. [Hansch, C. et al. (1995)]. The measurement process time, including equilibration, using the microfluidic mixing chip dispensing into functionalized glass wool fiber system was on the scale of minutes, which is much faster than the conventional shake-flask method which generally takes days.

### EMBODIMENTS

1. A method, including:
injecting an aqueous solution including a first tracer into a first inlet of a microfluidic mixing device and injecting crude oil into a second inlet of the microfluidic mixing device;
mixing the aqueous solution and the crude oil in the microfluidic mixing device to form a mixture including the aqueous solution and the crude oil;
disposing the mixture in a separation tube including functionalized fibers;
using the separation tube to separate an aqueous phase of the mixture from a crude oil phase of the mixture;
using a high-performance liquid chromatography (HPLC) system capable of detecting an optical parameter to measure the first tracer in the aqueous phase; and
using the measurement of the first tracer in the aqueous phase to determine a partition coefficient between the crude oil and the aqueous solution of the first tracer.
   2. The method of embodiment 1, further including:
constructing a calibration curve for the first tracer based on the optical parameter; and
using the calibration curve with the measurement of the first tracer in the aqueous phase to determine the partition coefficient between the crude oil and the aqueous solution of the first tracer.
   3. The method of embodiment 1 or 2, wherein the aqueous phase flows through the separation tube and the crude oil phase is retained in the separation tube due to the functionalized fibers.
   4. The method of any one of embodiments 1-3, wherein the functionalized fibers comprise —CₙH₂ₙ₊₁ groups, where n=8-20.
   5. The method of embodiment 4, the functionalized fibers comprise octadecyl groups.
   6. The method of embodiment 4, wherein the functionalized fibers comprise glass wool fibers functionalized with the —CₙH₂ₙ₊₁ groups.
   7. The method of any one of embodiments 1-6, further including, prior to injecting the aqueous solution and the crude oil into the microfluidic mixing device, injecting the aqueous solution including the first tracer into the first inlet of the microfluidic mixing device.
   8. The method of any one of embodiments 1-7, wherein the optical parameter includes a member selected from the group consisting of UV-Vis absorption, fluorescence, time-resolved fluorescence, a Raman signal, and an IR signal.
   9. The method of any one of embodiments 1-8, wherein:
the aqueous solution further includes a second tracer; and
the method further includes determining a partition coefficient between the crude oil and the aqueous solution of the second tracer.
   10. The method of embodiment 9, further including, constructing a calibration curve for the second tracer based on the optical parameter.
   11. The method of any one of embodiments 1-10, wherein the aqueous solution includes a member selected from the group consisting of fresh water, seawater, and brine.
   12. A system including:
a microfluidic mixing chip including:
   a first inlet;
   a second inlet;
   an outlet; and
   an internal channel that provides fluid communication between the first inlet, the second inlet, and the outlet;
a separation tube including functionalized fibers; and
high-performance liquid chromatography (HPLC) system capable of detecting an optical parameter,
wherein:
   the outlet of the microfluidic mixing chip is in fluid communication with an inlet of the separation tube; and
   an outlet of the separation tube is in fluid communication with an inlet of the high-performance liquid chromatograph system.
      13. The system of embodiment 12, wherein the functionalized fiber includes —CₙH₂ₙ₊₁ groups, where n=8-20.
      14. The system of embodiment 13, the functionalized fibers include octadecyl groups.
      15. The system of embodiment 13, wherein the functionalized fibers include glass wool functionalized with the —CₙH₂ₙ₊₁ groups.
      16. The system of any one of embodiments 12-15, wherein the optical parameter includes a member selected from the group consisting of UV-Vis absorption, fluorescence, time-resolved fluorescence, a Raman signal, and an IR signal.
      17. The system of any one of embodiments 12-16, wherein the system is configured so that, during use of the system, when an aqueous solution including a tracer is input into the first inlet and crude oil is input into the second inlet:
the microfluidic mixing chip mixes the aqueous solution and the crude oil to form a mixture including the aqueous solution and the crude oil;
the separation tube separates an aqueous phase of the mixture from a crude oil phase of the mixture; and
the HPLC system measures the tracer in the aqueous phase.
   18. The system of any one of embodiments 12-17, wherein the separation tube has a length of from 50 mm to 500 mm.
   19. The system of any one of embodiments 12-18, wherein the separation tube has a diameter of from 1 mm to 5 mm.
   20. The system of any one of embodiments 12-19, wherein the separation tube includes a tube including a member selected from the group consisting of borosilicate glass and polyether ether ketone.

What is claimed:

1. A method, comprising:
injecting an aqueous solution comprising a first tracer into a first inlet of a microfluidic mixing device and injecting crude oil into a second inlet of the microfluidic mixing device;
mixing the aqueous solution and the crude oil in the microfluidic mixing device to form a mixture comprising the aqueous solution and the crude oil;
disposing the mixture in a separation tube comprising functionalized fibers;
using the separation tube to separate an aqueous phase of the mixture from a crude oil phase of the mixture;
using a high-performance liquid chromatography (HPLC) system capable of detecting an optical parameter to measure the first tracer in the aqueous phase; and
using the measurement of the first tracer in the aqueous phase to determine a partition coefficient between the crude oil and the aqueous solution of the first tracer.

2. The method of claim 1, further comprising:
constructing a calibration curve for the first tracer based on the optical parameter; and
using the calibration curve with the measurement of the first tracer in the aqueous phase to determine the partition coefficient between the crude oil and the aqueous solution of the first tracer.

3. The method of claim 1, wherein the aqueous phase flows through the separation tube and the crude oil phase is retained in the separation tube due to the functionalized fibers.

4. The method of claim 1, wherein the functionalized fibers comprise —CₙH₂ₙ₊₁ groups, where n=8-20.

5. The method of claim 4, the functionalized fibers comprise octadecyl groups.

6. The method of claim 4, wherein the functionalized fibers comprise glass wool fibers functionalized with the —CₙH₂ₙ₊₁ groups.

7. The method of claim 1, further comprising, prior to injecting the aqueous solution and the crude oil into the microfluidic mixing device, injecting the aqueous solution comprising the first tracer into the first inlet of the microfluidic mixing device.

8. The method of claim 1, wherein the optical parameter comprises a member selected from the group consisting of UV-Vis absorption, fluorescence, time-resolved fluorescence, a Raman signal, and an IR signal.

9. The method of claim 1, wherein:
the aqueous solution further comprises a second tracer; and
the method further comprises determining a partition coefficient between the crude oil and the aqueous solution of the second tracer.

10. The method of claim 9, further comprising, constructing a calibration curve for the second tracer based on the optical parameter.

11. The method of claim 1, wherein the aqueous solution comprises a member selected from the group consisting of fresh water, seawater, and brine.

12. A system comprising:
a microfluidic mixing chip comprising:
a first inlet;
a second inlet;
an outlet; and
an internal channel that provides fluid communication between the first inlet, the second inlet, and the outlet;
a separation tube comprising functionalized fibers; and
high-performance liquid chromatography (HPLC) system capable of detecting an optical parameter,
wherein:
the outlet of the microfluidic mixing chip is in fluid communication with an inlet of the separation tube; and
an outlet of the separation tube is in fluid communication with an inlet of the high-performance liquid chromatograph system.

13. The system of claim 12, wherein the functionalized fiber comprises —CₙH₂ₙ₊₁ groups, where n=8-20.

14. The system of claim 13, the functionalized fibers comprise octadecyl groups.

15. The system of claim 13, wherein the functionalized fibers comprise glass wool functionalized with the —CₙH₂ₙ₊₁ groups.

16. The system of claim 12, wherein the optical parameter comprises a member selected from the group consisting of UV-Vis absorption, fluorescence, time-resolved fluorescence, a Raman signal, and an IR signal.

17. The system of claim 12, wherein the system is configured so that, during use of the system, when an aqueous solution comprising a tracer is input into the first inlet and crude oil is input into the second inlet:
the microfluidic mixing chip mixes the aqueous solution and the crude oil to form a mixture comprising the aqueous solution and the crude oil;
the separation tube separates an aqueous phase of the mixture from a crude oil phase of the mixture; and
the HPLC system measures the tracer in the aqueous phase.

18. The system of claim 12, wherein the separation tube has a length of from 50 mm to 500 mm.

19. The system of claim 12, wherein the separation tube has a diameter of from 1 mm to 5 mm.

20. The system of claim 12, wherein the separation tube comprises a tube comprising a member selected from the group consisting of borosilicate glass and polyether ether ketone.
